(19) United States
(12) Patent Application Publication
(10) Pub. No.: US 2002/0115490 A1
(43) Pub. Date: Aug. 22, 2002

(54) Accounting system for arcade games

(76) Inventors: Fredrick Burnet, Daytona Beach, FL (US); Walter A. Howell, Ormond Beach, FL (US); Michael S. Lane, Daytona Beach, FL (US); David A. Wise, Daytona Beach, FL (US)

Correspondence Address: STANDLEY & GILCREST LLP, 495 METRO PLACE SOUTH, SUITE 210, DUBLIN, OH, 43017, US

(21) Appl. No.: 09/992,280

(22) Filed: Nov. 14, 2001

Related U.S. Application Data
(60) Provisional application No. 60/248,428, filed on Nov. 14, 2000.

(51) Int. Cl. A63F 13/00

(52) U.S. Cl. 463/49; 463/42; 463/25

(57) ABSTRACT

A system and method for sending and receiving game accounting data from an arcade game processing system to a mobile data collection unit. The data may be transmitted using various protocols such as infrared, radio or serial data transmission. The present invention also has a new electromechanical method of collecting information on prize dissemination. By using a user-actuated method of input, e.g., buttons or switches, the game operator may efficiently and accurately track and store prize dissemination information.

### INCORPORATION BY REFERENCE

The subject matter of U.S. Pat. No. 5,439,230 to Mendes, Jr. is hereby incorporated by reference.

### SUMMARY AND BACKGROUND OF THE INVENTION

The present invention relates to the general field of arcade games, and more particularly, an arcade game having a novel accounting system for storing and collecting game accounting data.

The present invention relates to a novel method for uploading game accounting data from an arcade game processing system to a mobile data collection unit. The data may be transmitted using various protocols such as infrared, radio or serial data transmission. The present invention also has a new electromechanical method of collecting information on prize dissemination. By using an operator-actuated method of input, e.g., buttons or switches, the game operator may efficiently and accurately track and store prize dissemination information. The present invention also integrates a clock which allows the tracking of game accounting data with respect to time.

In addition to the features mentioned above, objects and advantages of the present invention will be readily apparent upon a reading of the following description.

### BRIEF DESCRIPTION OF THE DRAWINGS

Novel features and advantages of the present invention, in addition to those mentioned above, will become apparent to those skilled in the art from a reading of the following detailed description in conjunction with the accompanying drawings wherein similar reference characters refer to similar parts and in which:

FIG. 1 illustrates perspective view of one embodiment of a columnar race game;

FIG. 2 illustrates one embodiment of a block diagram of a processing system of an arcade race game of the present invention; and

FIG. 3 illustrates one embodiment of a block diagram of an output processing system of the present invention.

### DETAIL DESCRIPTION OF PREFERRED EMBODIMENT(S)

The preferred system herein described is not intended to be exhaustive or to limit the invention to the precise forms disclosed. They are chosen and described to explain the principles of the invention, and the application of the method to practical uses, so that others skilled in the art may practice the invention.

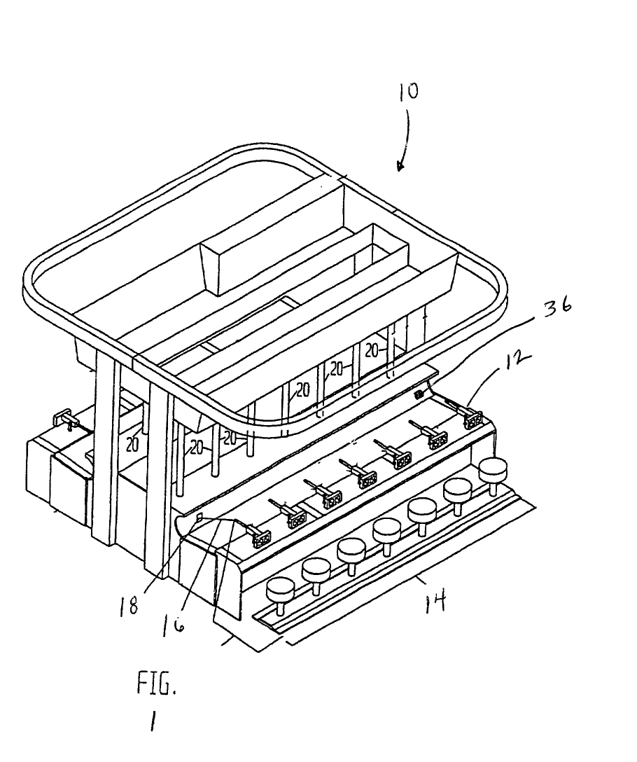

With reference to FIG. 1, one embodiment of an arcade game 10 is shown. The arcade game is a racing type arcade game where the contestants race other contestants. The contestants operate guns 12 at the operator stations 14. The contestants shoot a projectile 16, e.g., water, air, bullet, toward the target 18. If the target is hit, race indication device 20 is actuated to indicate race progression. The first contestant to have their race indication device reach a predetermined progress level is deemed the winner of the race. Generally, the winner of the game wins a prize of their choice. In alternative embodiments, the race indication device may be incorporated by using a rising water column, a rising column, a rising game piece or any other known methods.

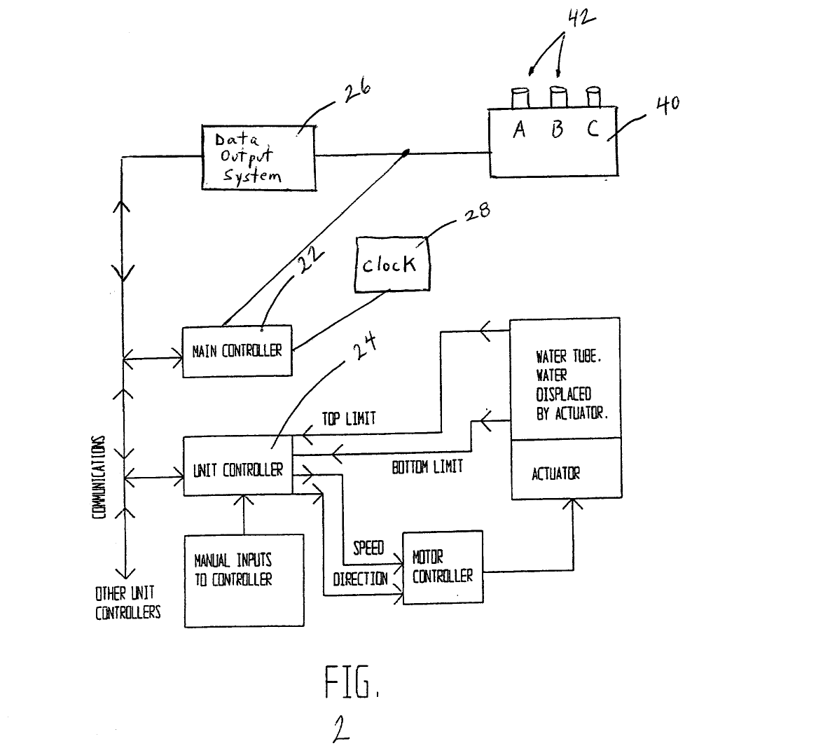

FIG. 2 illustrates one embodiment of a block diagram of a processing system of an arcade race game. In the disclosed embodiment, the processing system is comprised of a main controller 22 and a plurality of unit controllers 24 for each player station. In a preferred embodiment, the main controller stores the initial accounting data for the game. The processing system also is comprised of a data output system 26 used to transmit the game accounting data to a mobile processing unit. A clock may also be integrated into the processing system, shown at 28 in FIG. 2. The clock may be used to time-stamp the game accounting data to provide game data in the context of time. Such data would allow the game operator to easily determine revenue data with respect to time.

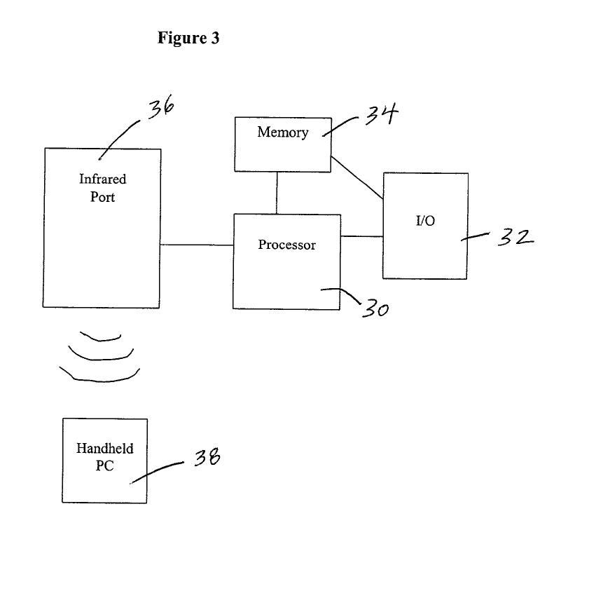

FIG. 3 illustrates one embodiment of a block diagram of an output processing system of the present invention. The system may be implemented via a microcontroller or a personal computer. In the preferred embodiment, the output processing system of the present invention is an infrared port. Alternative embodiments may include a radio transceiver or other wireless transmission device and protocol.

In one embodiment, the infrared port may be directly coupled to the processing system of the main controller. In the embodiment disclosed in FIG. 2, the infrared port is implemented via a processing system separate from the main controller. In one embodiment, data output system is comprised of a processor 30, I/O ports 32, a memory 34 and an infrared port 36. The data output system communicates with the main controller to receive game accounting data. The game accounting data may be sent to the data output system at predetermined times. In the preferred embodiment, the infrared port uses a standard Infrared Data Association (IrDA)-compliant communications for data transfer to an external computing device.

A supplied infrared port may be used if the processing system comes with such a port or an interface may be installed which converts a serial port into an IrDA-compatible infrared port. IrDA software drivers should also be installed in the system. Once the drivers are installed on the system, the communications settings screen of the operating system software (e.g., Windows, Linux, Palm, Window CE) may be set for infrared communication.

The game accounting data stored at the data output system may be sent to a handheld device 38, e.g., PC, having a compatible transmission protocol, e.g., infrared. The handheld device may be a Palm Pilot device programmed with the Palm operating system. In an alternative embodiment, the handheld may be a Window CE device programmed with the Window CE operating system. These devices may be programmed with a software program that uses the infrared port to obtain the game accounting data from the game. The program may be configured to ask for a valid security password before data transmission can be initiated.

The game accounting data may be comprised of: a game type identification, game identification, number of players total, number of players for a particular game cycle, total prizes given out, prize(s) given out for each game cycle, station where the winner sat, cost of sale for each prize, total revenue earned, total revenue earned per game cycle. This data may be stored according to time as previously described. Accordingly, the game accounting data may be analyzed with respect to time. In one embodiment, all of the above data items are computed by the game system and then sent to the handheld computer. In another embodiment, only certain ones of the data items are sent and the rest of the data items are calculated by the handheld computer.

A game cycle is preferably defined as the operation of one race, from start to finish. The game cycle is preferably initiated by switches at the player's stations which are actuated at the start of a race. The game cycle preferably ends when a contestant wins the race.

In one embodiment, the game accounting system of the present invention uses a data collection unit 40 for indicating which prize was won by a contestant. The data collection unit may be configured with buttons 42, or switches or any other known activation device. The data collection device may be a PC with a program for tracking prize dissemination, e.g., using a touch screen graphical interface. The data collection device is in data communication with either the data output system or the main controller to transmit inputted data to these systems. The data collection device is configured with a plurality of buttons or other actuation devices, each corresponding to a particular prize. Once a prize has been won by a contestant, the corresponding button or actuation device is actuated by the game attendant to indicate to the system that the particular prize has been won. This feature allows the game attendant to easily and accurately track the number of prizes disseminated and the particular prizes disseminated. By incorporating these numbers with the game accounting data, the revenue data, prize inventory and other pertinent information may be efficiently monitored. In one embodiment, the game accounting software of the present invention may be programmed to provide the inventory of prizes at each game station and provide a warning when it is time to restock the prizes at a particular station.

In operation, a park attendant may easily collect the game accounting data from the games according to the present invention merely by pointing the infrared port on the handheld towards the infrared port on the game. The game accounting data may be collected without interrupting the progress of game play or without physically connecting the handheld computer to the game.

It is also appreciated that the handheld unit may be used to send data to the game through the wireless data link to communicate predetermined information to the game. Having shown and described a preferred embodiment of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

We claim:

1. An apparatus for storing and collecting arcade game data comprising:
a game processing system;
a data output system in electrical communication with said game processing system; and
a data collection unit in wireless communication with said data output system.

2. The apparatus of claim 1 wherein said data collection unit communicates game accounting data to and from said data output system.

3. The apparatus of claim 1 wherein said game processing system comprises:
a main controller; and
a plurality of unit controllers.

4. The apparatus of claim 3 wherein said game processing system further comprises a clock.

5. The apparatus of claim 1 wherein said data output system comprises:
a processor;
a plurality of I/O ports;
memory; and
a communications port.

6. The apparatus of claim 5 wherein said communications port uses infrared, radio, or serial data transmissions.

7. The apparatus of claim 5 wherein said communications port uses standard Infrared Data Association (IrDA) compliant communications.

8. The apparatus of claim 5 wherein said data collection unit communicates game accounting data to and from said data output system through said communications port.

9. An apparatus for storing and collecting arcade game data comprising:
a game processing system;
an output processing system in electrical communication with said game processing system;
a data output system in electrical communication with said output processing system; and
a data collection unit in wireless communication with said data output system.

10. The apparatus of claim 9 wherein said data collection unit communicates game accounting data to and from said data output system.

11. The apparatus of claim 9 wherein said game processing system comprises:
a main controller; and
a plurality of unit controllers.

12. The apparatus of claim 11 wherein said game processing system further comprises a clock.

13. The apparatus of claim 9 wherein said output processing system is implemented via a micro controller or via a personal computer.

14. The apparatus of claim 9 wherein said data output system comprises:
a processor;
a plurality of I/O ports;
memory; and
a communications port.

15. The apparatus of claim 14 wherein said communications port uses infrared, radio, or serial data transmissions.

16. The apparatus of claim 14 wherein said communications port uses standard Infrared Data Association (IrDA) compliant communications.

17. The apparatus of claim 14 wherein said data collection unit communicates game accounting data to and from said data output system through said communications port.

18. A method for operating an accounting system for arcade game data comprising the steps of:
operating an arcade game having a game processing system;
storing game accounting data at said game processing system;
establishing wireless communications between said arcade game and a data collection unit;
collecting said game accounting data onto said data collection unit;
storing said game accounting data on said data collection unit;
processing said game accounting data on said data collection unit; and
allowing uninterrupted performance of game play from said arcade game during said collection of game accounting data.

19. The method of claim 18 further comprising actuating a device to indicate the award of a corresponding prize from said arcade game.
